(19) United States
(12) Patent Application Publication
(10) Pub. No.: US 2020/0342836 A1
(43) Pub. Date: Oct. 29, 2020

(54) Mouthpiece for a Woodwind Instrument

(71) Applicant: Ronald P. Coelho, Ridgefield, WA (US)

(72) Inventor: Ronald P. Coelho, Ridgefield, WA (US)

(21) Appl. No.: 16/690,048

(22) Filed: Nov. 20, 2019

Related U.S. Application Data
(60) Provisional application No. 62/840,289, filed on Apr. 29, 2019.

(51) Int. Cl. G10D 9/02

(52) U.S. Cl. CPC G10D 9/02

(57) ABSTRACT

A mouthpiece for a woodwind instrument, comprising a primary air duct, having an entrance and an exit, for primary airflow through the mouthpiece, a baffle at the entrance of the primary air duct, and a secondary air duct in the baffle, having an entrance and an exit, for secondary airflow through the mouthpiece.

### CROSS-REFERENCE TO RELATED APPLICATIONS

This application claims the benefit of the filing date of U.S. Provisional Application No. 62/840,289, filed Apr. 29, 2019 (Attorney Docket No. 37872.601P), the entire contents of which are incorporated by reference under 37 C.F.R. § 1.57.

### FIELD OF THE INVENTION

The various features relate to mouthpieces to be used with woodwind instruments. More particularly, one embodiment of the invention relates to a saxophone mouthpiece with enhanced flow dynamics for improved intonation control and ease of playing.

### BACKGROUND OF THE INVENTION

Woodwind instruments such as saxophones and clarinets generate their sound primarily in the mouthpiece, which is a hollow structure forming an air duct and which has a reed removably attached to it. The reed vibrates to form an oscillating air column inside the chamber of the mouthpiece which is then propagated through the neck portion of the instrument into the body. Depending on the opening or closing of valves individual notes are generated by interrupting or extending the air column.

The tone color is largely defined by the internal geometry of the mouthpiece. Of particular importance is the baffle, which is the portion of the mouthpiece directly behind the tip rail. The baffle creates some resistance in the air flow through the plenum defined by the mouth piece and the reed and causes a pressure gradient between the baffle portion of the mouthpiece and the post-baffle chamber of the mouthpiece defined by the floor and the side walls. Equally important as the pressure gradient is the shaping of the air stream passing over the baffle. In this context, it is important to understand that unless the melody is slurred, every new note initiated by a puff of air into the mouthpiece will meet an initial resistance when the puff of air exhaled by the player meets stagnant air in the chamber.

It is highly desirable to have a mouthpiece that provides well accentuated intonation but at the same time is “free blowing”, however, the two attributes are somewhat opposed to each other. It is therefore clear that a better solution is needed to provide an optimal ease of playing along with superb accentuation.

### BRIEF DESCRIPTION OF THE DRAWINGS

FIG. 1 illustrates a lateral and frontal view of a mouthpiece used with a saxophone as it is known in the prior art.

FIG. 2 illustrates a lateral and frontal view of a mouthpiece used with a woodwind instrument, such as a saxophone, having an additional air duct according to an embodiment of the invention.

FIG. 3 illustrates a lateral and frontal view of a mouthpiece used with a woodwind instrument, such as a saxophone, having an extended additional air duct according to an embodiment of the invention.

FIG. 4 illustrates a lateral and frontal view of a mouthpiece used with a woodwind instrument, such as a saxophone, having a tube insert for an extended additional air duct, according to an embodiment of the invention.

FIG. 5 illustrates a lateral and frontal view of a mouthpiece used with a woodwind instrument, such as a saxophone, having a tube insert for an extended additional air duct with the tube bent at the throat-facing end according to an embodiment of the invention.

FIG. 6 illustrates a lateral and frontal view of a mouthpiece used with a woodwind instrument, such as a saxophone, having an auxiliary air duct co-axial with the bore-facing end of the mouthpiece, according to an embodiment of the invention.

FIG. 7 illustrates a ventral view of a mouthpiece used with a woodwind instrument, such as a saxophone, having an additional air duct with an elliptical intake and a substantially circular egress according to an embodiment of the invention.

FIG. 8 illustrates a ventral view of a mouthpiece used with a woodwind instrument, such as a saxophone, having an additional air duct, according to another embodiment of the invention.

FIG. 9 illustrates a ventral view of a mouthpiece used with a woodwind instrument, such as a saxophone, having an additional air duct, according to another embodiment of the invention.

FIG. 10 illustrates a ventral view of a mouthpiece used with a woodwind instrument, such as a saxophone, having an additional air duct, according to another embodiment of the invention.

FIG. 11 illustrates a ventral view of a mouthpiece used with a woodwind instrument, such as a saxophone, having an additional air duct, according to another embodiment of the invention.

FIG. 12 illustrates a ventral view of a mouthpiece used with a woodwind instrument, such as a saxophone, having an additional air duct, according to another embodiment of the invention.

FIG. 13 illustrates a ventral view of a mouthpiece used with a woodwind instrument, such as a saxophone, having at least two additional air ducts, according to another embodiment of the invention.

### DETAILED DESCRIPTION OF THE INVENTION

In the following detailed description of the invention, numerous specific details are set forth in order to provide a thorough understanding of the invention. However, the invention may be practiced without these specific details. In other instances, well known methods, procedures, and/or components have not been described in detail so as not to unnecessarily obscure embodiments of the invention.

In the following description, certain terminology is used to describe certain features of one or more embodiments. The term woodwind instrument may refer to a saxophone or a clarinet or any other musical instrument using a vibrating reed, including but not limited to electronic instruments or pipe organs.

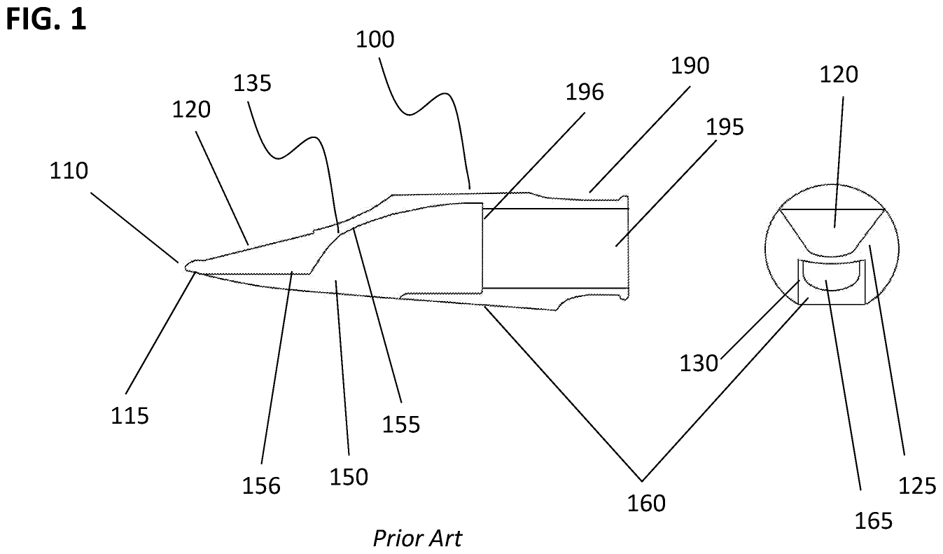

FIG. 1 illustrates a lateral and frontal view of a cross section of a mouthpiece as it is known in the prior art. The mouthpiece 100 extends from a tip 110 to a bore 195 at the end of a shank 190. The tip 110 is defined by a tip rail 115 at its bottom side or portion and extends into a bite plate 120 at its upper side or portion. The bite plate 120 extends through side walls or chamfers 125 towards the bottom of the mouthpiece where the side walls terminate in lateral rails 130. The side walls and bite plate in combination form a beak 135 of the mouthpiece. The beak contains the chamber 150 of the mouthpiece, wherein the tip rail 115, the lateral rails 130 and the anterior edge of a reed table 160 form a window, or entrance, 165 into the chamber. The chamber 150 is a hollow structure, providing a primary air duct for airflow through the mouthpiece, extending from the window 165 towards the bore 195, where the primary airflow exits the chamber and enters the bore 195. The bore is a cylindrical opening running in a substantially coaxial manner inside the shank 190, from the exit of chamber 150 to the end of shank 190, and adapted to receive the woodwind instrument's neck. The transition between the chamber 150 and the bore 195 is called the throat 196. The interior top surface of the chamber 150 is called the floor 155 and may be raised to form a baffle 156. The baffle 156 introduces restriction to the primary airflow into the chamber resulting in turbulences and differences in air stream velocity that can build up to create resistance of the mouthpiece when the fast moving air passing over, and bending around, the baffle hits a substantially slower or even standing air pocket in the chamber.

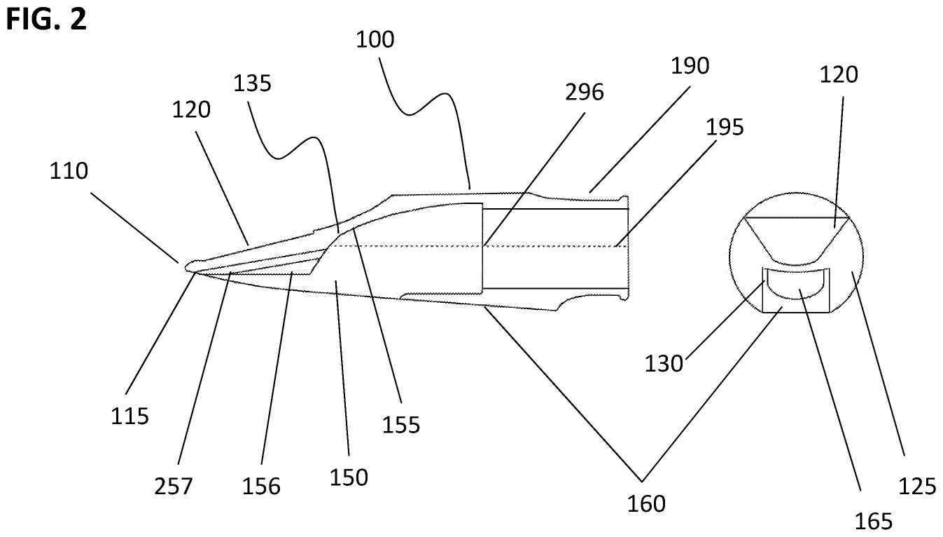

FIG. 2 illustrates an embodiment of the invention, in which a secondary air duct for additional airflow through the mouthpiece is formed by a tunnel 257 in the baffle 156. The entrance or intake of the secondary air duct is behind the tip rail 115. The exit or egress of the secondary air duct is aimed more or less at the center 296 of the throat 196, i.e., aimed at the center of the exit or transition from the chamber 150 to the bore 195. However, different angles of the secondary air duct may be possible, allowing projection of the additional air above or below the center of the throat. When the player blows into the mouthpiece, the additional, or secondary airflow will pass through the tunnel 257 at high velocity and enter the chamber 150. The stream of air passing through the tunnel 257 has a somewhat shorter path towards the throat than the air bending over the baffle 156 into the chamber 150. Moreover, the central projection of the stream of air may cause a Venturi effect within the chamber, thereby resulting in reduced back pressure of the mouthpiece, since the air passing through the small cross-sectional area tunnel 257 will draw in air from the chamber 150 into the bore 195. This may also result in a Bernoulli effect of the air passing through the tunnel 257 and having a higher velocity than the air bending over the baffle 156.

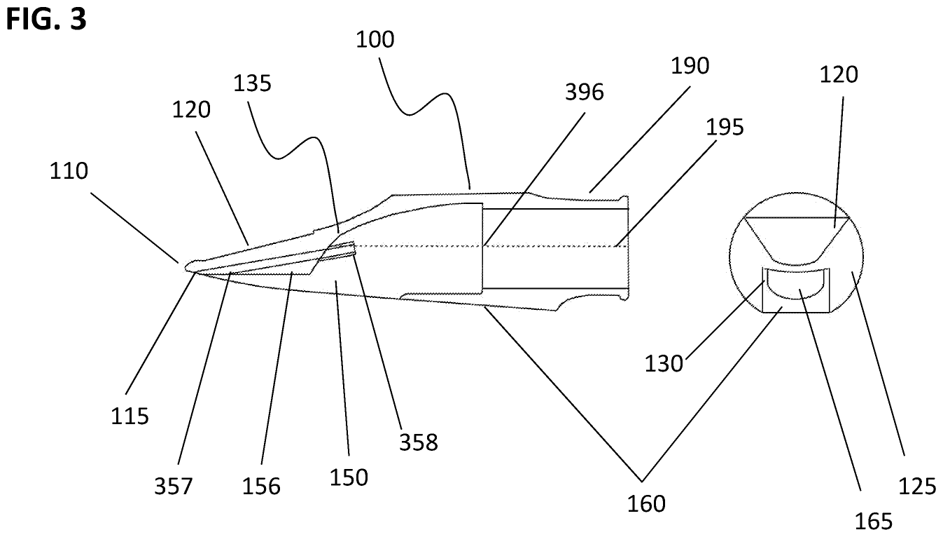

FIG. 3 illustrates an embodiment of the invention in which the tunnel 357 continues into an extended tube 358 projecting into the chamber 150 and terminating closer to the throat 396.

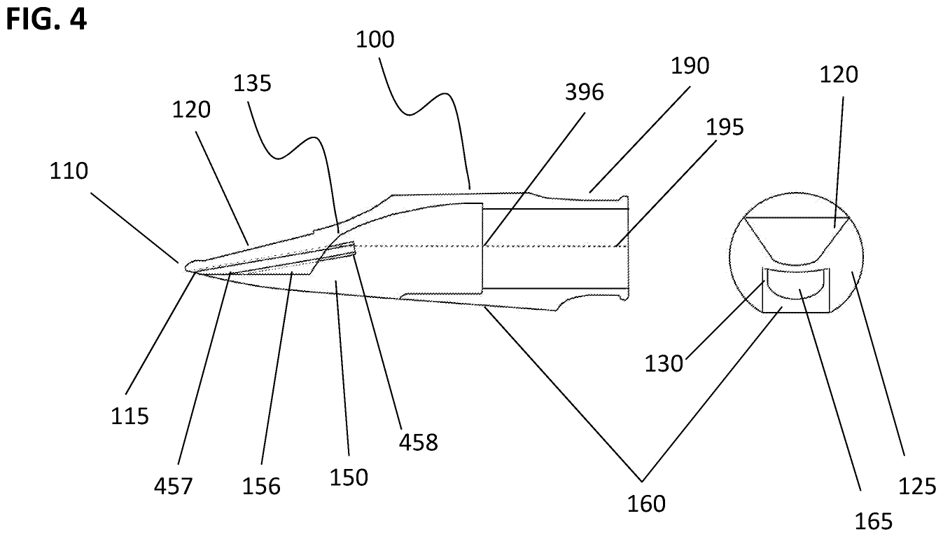

In another embodiment shown in FIG. 4, the extended tube 458 is formed by an insert into the tunnel 457 for better ease of manufacturing and custom adjustment of its length inside the chamber. In another embodiment the tube insert is inserted and length-adjusted through the tip portion of the tunnel 457, secured in its final position and machined to be coplanar with the tip-facing surface of the baffle.

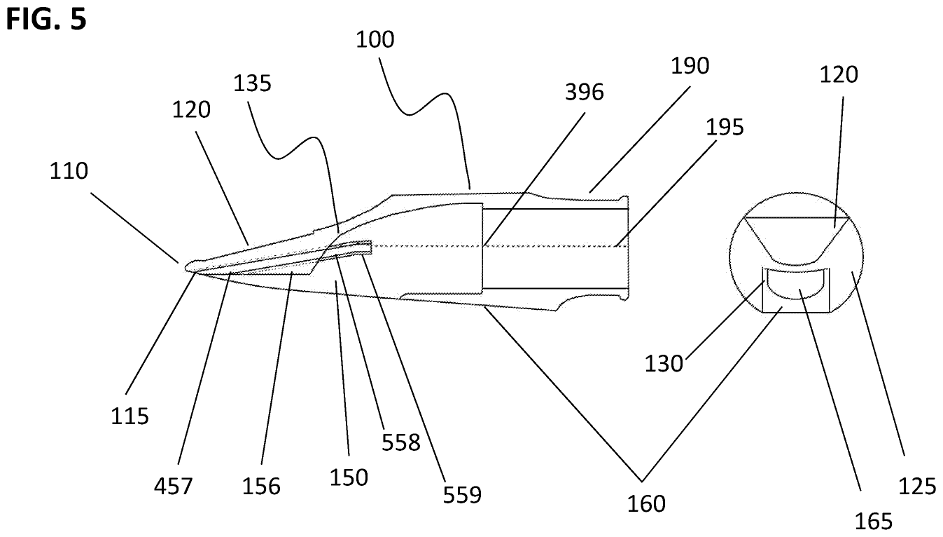

FIG. 5 illustrates another embodiment, the tube insert 558 is bent at its throat-facing end 559. This may allow for better centering and/or co-axial orientation of the air stream hitting the bore and, thereby, increasing the efficiency of the Venturi effect. Alternatively, the air stream may be offset from the center of the bore to create different timbres. For assembly, the bent tube may be inserted from the shank end of the mouth piece, that is, through the bore 195 and throat 196 but the tube can be guided through the window 165.

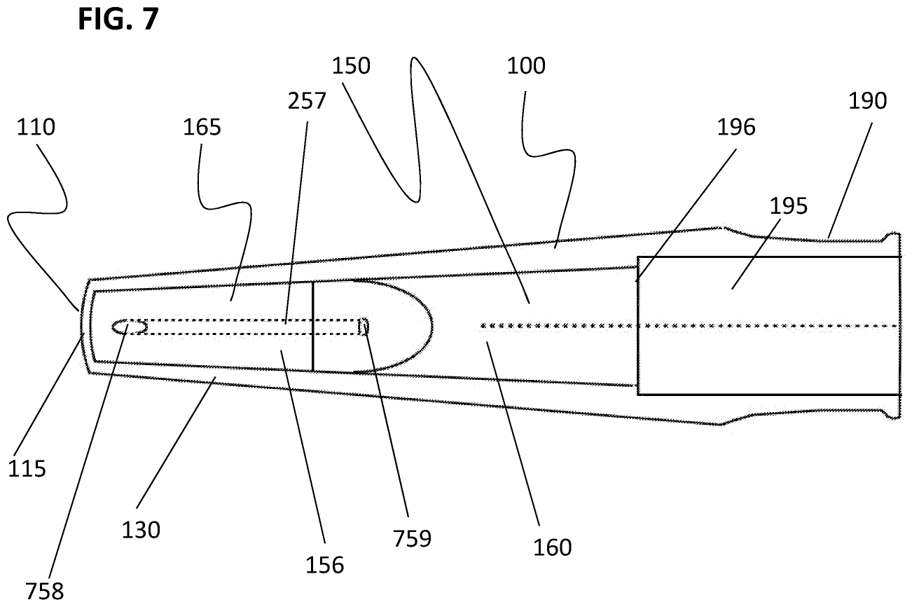

In yet another embodiment shown in FIG. 7, the tip-facing opening of the tunnel has a substantially elliptical shape 758 whereas the chamber-facing opening of the tunnel has a substantially circular shape 759 with a smaller area than the tip facing opening.

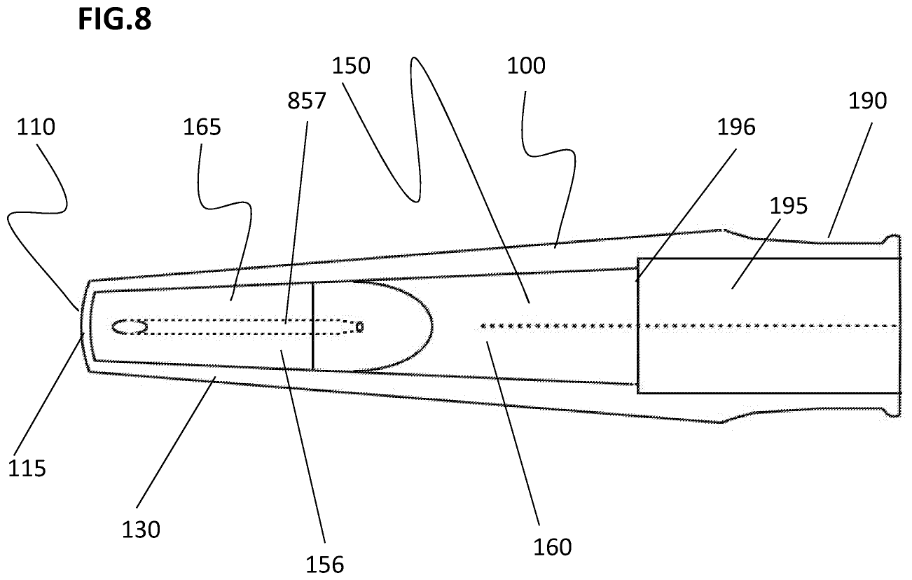

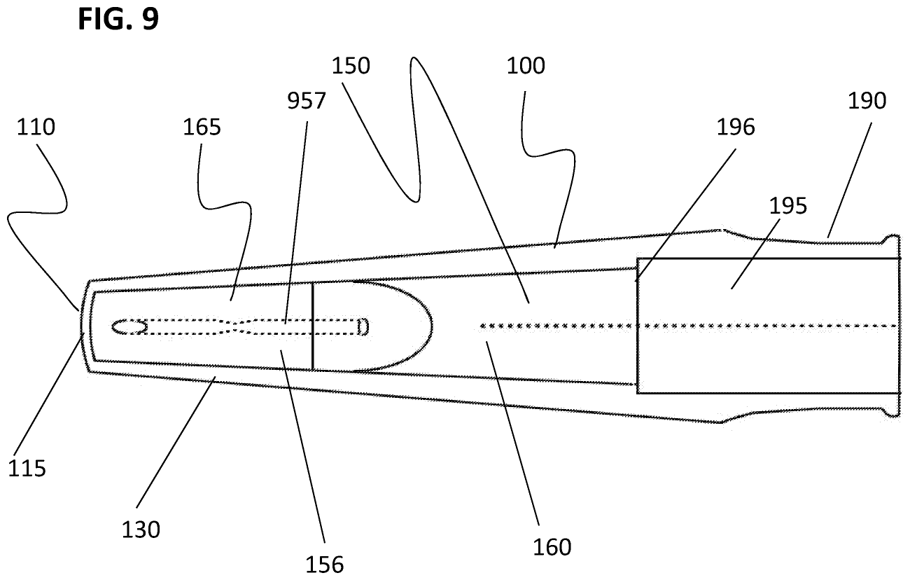

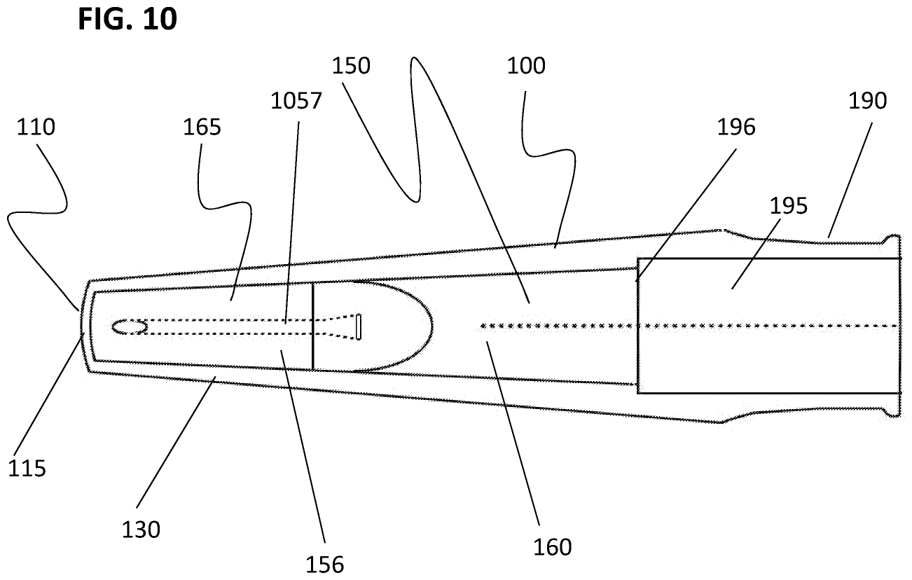

In yet another embodiment of the invention shown in FIG. 8, the tunnel is tapered, for example, the tunnel has a conical shape 857, or, as shown in FIG. 9, it may be hour glass-shaped 957 or else, as shown in FIG. 10, is formed as a flattened tube 1057.

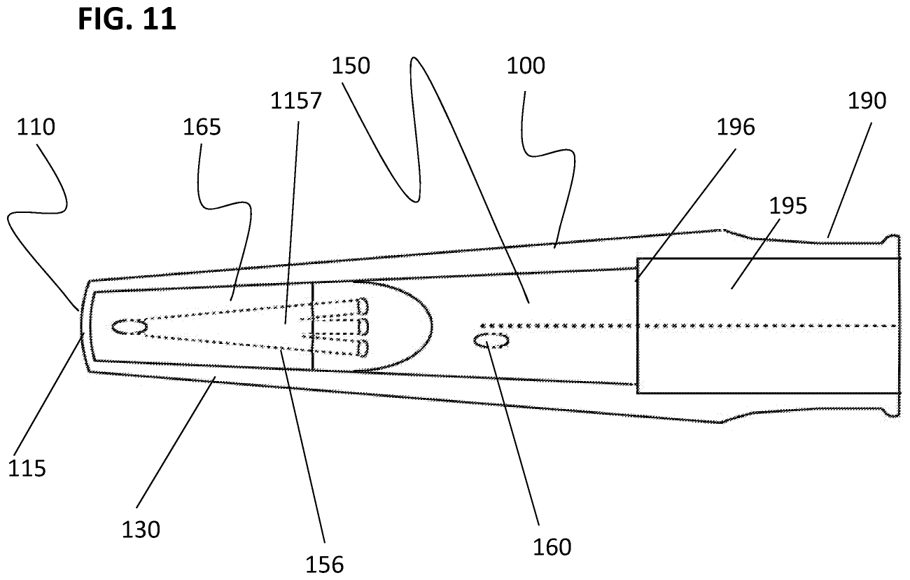

In yet another embodiment of the invention shown in FIG. 11, the tunnel 1157 has a common intake or entrance and the exit or egress of the tunnel splits into a manifold egress comprising a plurality of points of egress.

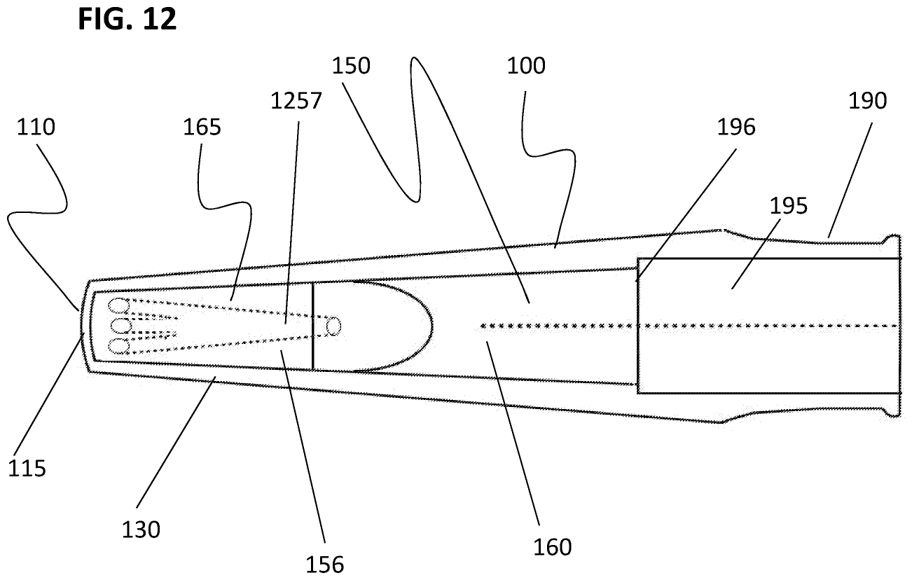

In yet another embodiment of the invention shown in FIG. 12, the entrance to tunnel 1257 comprises a plurality of intakes or points of ingress that converge into the tunnel, and the exit to the tunnel comprises a common egress.

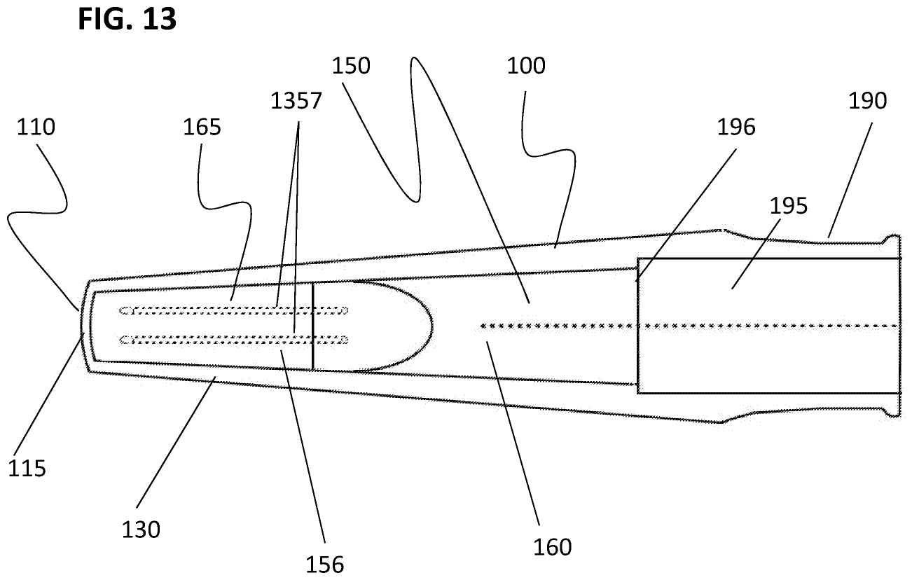

In yet another embodiment of the invention shown in FIG. 13, two or more tunnels 1357 are arranged, substantially in parallel, thereby providing for a secondary air duct, and a third, or tertiary, air duct in addition to the primary air duct. In an alternative embodiment, the two or more tunnels may be oriented at an angle with respect to each other, whereby either the respective entrances of the tunnels are closer than the exits, or vise versa.

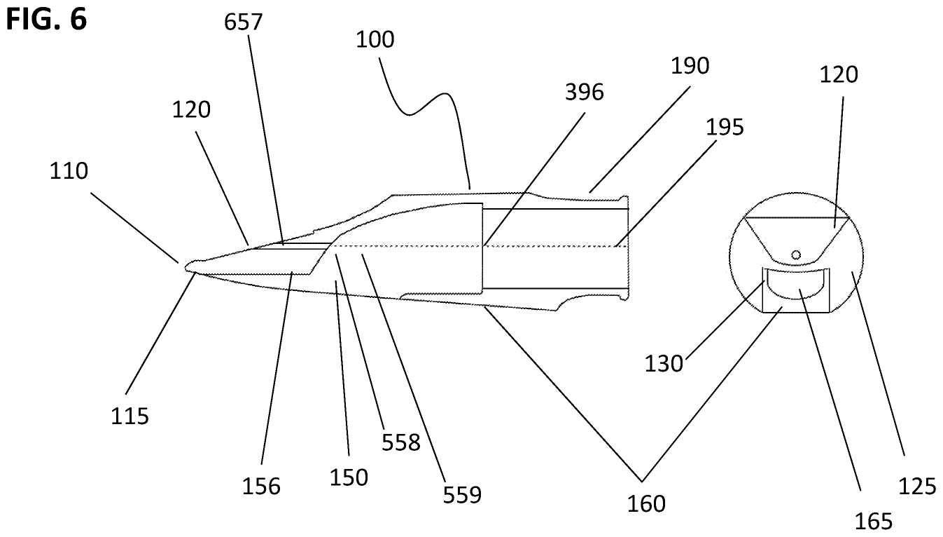

As illustrated in FIG. 2, in one embodiment of the invention, the secondary air duct for additional airflow through the mouthpiece is formed by a tunnel 257 in the baffle 156. In that embodiment, the entrance of the secondary air duct is at or near the tip rail 115 of the mouthpiece. In yet another embodiment of the invention shown in FIG. 6, the entrance of the secondary air duct, that is, the tunnel opening 657, is at or around the bite plate, and then continues into the chamber in a direction that is substantially co-axial with the bore. An extension of the tunnel as described in FIGS. 3 and 4 or different shapes as depicted in FIGS. 7-10 may be used for increasing the Venturi effect or changing the timbre.

1. A mouthpiece for a woodwind instrument, comprising:
a primary air duct, having an entrance and an exit, for primary airflow through at least a portion of the mouthpiece;
a baffle at the entrance of the primary air duct; and
a secondary air duct in the baffle, having an entrance and an exit, for secondary airflow through the baffle and into the primary air duct, wherein the exit for the secondary air duct is aimed at one of: the center, above the center, and below the center, of the exit of the primary air duct.

2. (canceled)

3. The mouthpiece of claim 1, wherein the tubular shaped secondary air duct is shorter in length than the primary air duct.

4. The mouthpiece of claim 1 wherein the secondary air duct provides a higher velocity for the secondary airflow than a velocity for the primary airflow through the primary air duct.

5. The mouthpiece of claim 1, wherein the secondary air duct extends beyond the baffle and into the primary air duct.

6. The mouthpiece of claim 1, wherein the secondary air duct comprises:
a tunnel extending from the entrance of the secondary air duct and through the baffle; and
a tube extending the secondary air duct from the tunnel in the baffle and into the primary air duct.

7. The mouthpiece of claim 1, wherein the secondary air duct comprises a tube inserted in a tunnel through the baffle.

8. The mouthpiece of claim 7, wherein the tube extends from the tunnel in the baffle and into the primary air duct.

9. The mouthpiece of claim 8, wherein the tube is bent at a point at or after where it extends from the tunnel in the baffle and into the primary air duct.

10. The mouthpiece of claim 1, wherein the entrance to the secondary air duct is substantially elliptical in shape.

11. The mouthpiece of claim 10, wherein the exit from the secondary air duct is substantially circular in shape.

12. The mouthpiece of claim 11, wherein the exit from the secondary air duct has a smaller cross-sectional area than the entrance to the secondary air duct.

13. The mouthpiece of claim 1, wherein the secondary air duct is shaped according to one of: an hour glass shape, a flattened or oval tube shape, and a conical shape, between the entrance and exit of the secondary air duct.

14. The mouthpiece of claim 1, wherein the entrance of the secondary air duct comprises a plurality of points of ingress.

15. The mouthpiece of claim 1, wherein the exit of the secondary air duct comprises a plurality of points of egress.

16. The mouthpiece of claim 1, further comprising a third air duct in the baffle, having an entrance and an exit, for a third airflow through the baffle and into the primary air duct.

17. The mouthpiece of claim 16, wherein the third air duct is arranged according to one of: substantially parallel with the secondary air duct, and at an angle with respect to the secondary air duct.

18. The mouthpiece of claim 1, wherein the mouthpiece further comprises:
a tip, the tip comprising:
a tip rail at a lower portion of the tip; and
a bite plate at an upper portion of the tip; and
wherein the entrance of the secondary air duct in the baffle is located at the bite plate.
